(19) United States
(12) Patent Application Publication
(10) Pub. No.: US 2012/0054453 A1
(43) Pub. Date: Mar. 1, 2012

(54) INFORMATION PROCESSING APPARATUS, INFORMATION PROCESSING METHOD, AND PROGRAM

(75) Inventors: Kayo Watanabe, Kanagawa (JP); Makoto Korehisa, Kanagawa (JP)

(73) Assignee: SONY CORPORATION, TOKYO (JP)

(21) Appl. No.: 13/211,370

(22) Filed: Aug. 17, 2011

(30) Foreign Application Priority Data
Aug. 25, 2010 (JP) P2010-188898

(51) Int. Cl. G06F 12/00

(52) U.S. Cl. 711/154; 711/E12.001

(57) ABSTRACT

An information processing apparatus includes: a main memory apparatus capable of storing one or more programs read and processed by a central processing unit and holding stored contents by securing an energized state even under suspension of a system; a nonvolatile storage apparatus to store in advance an activation program necessary to activate the system and selection target programs available on the activated system; a use frequency management unit to manage a use frequency of each selection target program; and a main memory construction unit to determine one or more selection target programs based on the use frequency of each selection target program and load a program necessary for the main memory apparatus or a part thereof from the nonvolatile storage apparatus in system shutdown processing such that at least the determined one or more selection target programs and the activation program are stored in the main memory apparatus in system activation.

### CROSS-REFERENCE TO RELATED APPLICATION

The present application claims priority from Japanese Patent Application No. JP 2010-188898 filed in the Japanese Patent Office on Aug. 25, 2010, the entire content of which is incorporated herein by reference.

### BACKGROUND

The present disclosure relates to an information processing apparatus, an information processing method, and a program, in which an energized state is secured for a RAM (Random Access Memory) used as a main memory apparatus even under suspension of a system and accordingly contents of a main memory at a time of system shutdown are taken over at the next system activation.

An information processing apparatus such as a personal computer has a suspend/resume function as a technique of speeding up the activation of a system. The suspend/resume function is to hold contents of a main memory that are details of work when a power supply is turned off in a nonvolatile storage such as a hard disk drive, read the contents from the nonvolatile storage when the power supply is turned on, and write the contents back to the main memory, to thereby restore the details of work when the power supply is turned off. The information processing apparatus having the suspend/resume function can select, at shutdown operation, one of a shutdown method of setting the suspend/resume function to be effective and a shutdown method of setting the suspend/resume function to be ineffective.

On the other hand, in many cases, embedded equipment such as a smartphone adopts a configuration in which a system is activated or shut down by only turning on/off a push button switch, for example, in order to simplify operations. By a restriction on the configuration of an operation unit as described above, the suspend/resume function is not generally incorporated in the embedded equipment such as a smartphone.

Further, for example, in a system where a program is loaded from a nonvolatile storage apparatus into a volatile storage apparatus used as a main memory and processing is performed, a time for loading the program directly affects an activation time of a system and an activation time of an application program, which is a barrier against the improvement of responsiveness.

Japanese Patent Application Laid-open No. 2009-266122 (paragraph [0075] etc.; hereinafter, referred to as Patent document 1) discloses the technique of reloading only a part whose value is changed out of a variable area of a program loaded into a main memory apparatus in system shutdown processing in order to shorten a time required to load the program and shorten an activation time. In other words, as compared to a case where the entire variable area of the program is reloaded, a time required for reload is shortened and an activation time can be shortened.

Further, Japanese Patent Application Laid-open No. 2001-337842 (paragraphs [0017] to [0022] etc.; hereinafter, referred to as Patent document 2) discloses the technique of prohibiting overwriting of a part having a high use frequency (module) in a program loaded from a nonvolatile storage apparatus into a volatile storage apparatus and permitting overwriting of a part having a low use frequency (module) in the program, to thereby constantly leave the part having a high use frequency in the volatile storage apparatus and shorten a response time with respect to a user's request.

### SUMMARY

However, Patent document 1 assumes that predetermined types of program groups are loaded into the main memory apparatus. In other words, a circumstance in which a nonvolatile storage apparatus stores a plurality of programs that exceed the capacity of a main memory apparatus as a whole and a program appropriately selected therefrom by a user or the like is loaded into the main memory apparatus for use is not considered. The present disclosure assumes such a circumstance.

In Patent document 2, the following problem may be caused in equipment having a severe restriction on the capacity of a volatile storage apparatus. For example, as described above, it is assumed that a nonvolatile storage apparatus stores a plurality of modules that exceed the capacity of a main memory apparatus as a whole, and a module appropriately selected therefrom by a user is loaded into the main memory apparatus for use. In such a case, when the capacity of the main memory apparatus is completely consumed by a module having a high use frequency, a module having a use frequency not particularly high is difficult to be loaded into the main memory apparatus and used even if the module has to be used. Therefore, in order to cope with the problem, other operations or processing such as preparation of a special command for forcibly canceling a setting of prohibiting overwriting of a unit of module or the whole of module become necessary, and sufficient responsiveness is difficult to be obtained in the equipment having a severe registration on the capacity of the volatile storage apparatus.

In view of the circumstances as described above, it is desirable to provide an information processing apparatus, an information processing method, and a program that are capable of obtaining excellent responsiveness in response to a user's request under a condition of a severe restriction on the capacity of a main memory apparatus.

According to an embodiment of the present disclosure, there is provided an information processing apparatus including: a main memory apparatus configured to be capable of storing one or more programs read and processed by a central processing unit and holding stored contents by securing an energized state even under suspension of a system; a nonvolatile storage apparatus configured to store in advance an activation program necessary to activate the system and a plurality of selection target programs available on the activated system; a use frequency management unit configured to manage a use frequency of each of the plurality of selection target programs; and a main memory construction unit configured to determine one or more selection target programs based on the use frequency of each of the plurality of selection target programs and load one of a program necessary for the main memory apparatus and a part of the program from the nonvolatile storage apparatus in system shutdown processing such that at least the determined one or more selection target programs and the activation program are stored in the main memory apparatus at a time of system activation.

In the embodiment of the present disclosure, an environment in which an activation program and one or more selection target programs having a high load priority are stored in a main memory apparatus is secured in the next system activation, with the result that a time for loading the activation program at a time of system activation or a time for loading a selection target program having a high use frequency are totally shortened. Therefore, it is possible to obtain excellent responsiveness in response to a user's request under a condition of a severe restriction on the capacity of the main memory apparatus.

The main memory construction unit may load one of a missing selection target program and a part of the selection target program into the main memory apparatus from the nonvolatile storage apparatus such that the determined one or more selection target programs and the activation program are stored in the main memory apparatus immediately after the system activation.

The main memory construction unit may calculate a load priority for each of the plurality of selection target programs based on the use frequency of each of the plurality of selection target programs and a weight of the use frequency set in advance for each of the plurality of selection target programs, and determine one or more selection target programs used on the system based on the calculated load priority for each of the plurality of selection target programs. For example, by setting the weight of the use frequency of a selection target program having a relatively large size consumed in the main memory apparatus to be lower and setting the weight of the use frequency of a selection target program having a relatively smaller size consumed in the main memory apparatus to be higher, it is possible to avoid a case where the capacity of the main memory apparatus is consumed to a large extent by the selection target program having a large size consumed and another selection target program having a relatively high priority is not loaded. In other words, the improvement of a use efficiency of the capacity of the main memory apparatus can be expected.

The main memory construction unit may load one of a selection target program necessary for the main memory apparatus and a part of the selection target program from the nonvolatile storage apparatus such that the determined one or more selection target programs and the activation program are stored in the main memory apparatus immediately after the system activation, and preferentially delete, from the main memory apparatus, selection target programs in an ascending order of load priority out of the plurality of selection target programs stored in the main memory apparatus in a case where the main memory apparatus has a shortage of a free space.

According to another embodiment of the present disclosure, there is provided an information processing method for an information processing apparatus including a main memory apparatus and a nonvolatile storage apparatus. The main memory apparatus is configured to be capable of storing a program read and processed by a central processing unit and holding stored contents by securing an energized state even under suspension of a system. The nonvolatile storage apparatus is configured to store in advance an activation program necessary to activate the system and a plurality of selection target programs available on the activated system. The information processing method includes: managing, by a use frequency management unit, a use frequency of each of the plurality of selection target programs except for programs including the activation program; and determining, by a main memory construction unit, in system shutdown processing, one or more selection target programs used on the system based on the use frequency of each of the plurality of selection target programs and loading one of a selection target program necessary for the main memory apparatus and a part of the selection target program from the nonvolatile storage apparatus such that the determined one or more selection target programs and the activation program are stored in the main memory apparatus immediately after the system activation.

According to another embodiment of the present disclosure, there is provided a program causing an information processing apparatus to operate, the information processing apparatus including a main memory apparatus and a nonvolatile storage apparatus. The main memory apparatus is configured to be capable of storing a program read and processed by a central processing unit and holding stored contents by securing an energized state even under suspension of a system. The nonvolatile storage apparatus is configured to store in advance an activation program necessary to activate the system and a plurality of selection target programs available on the activated system. The program causes the information processing apparatus to function as: a use frequency management unit configured to manage a use frequency of each of the plurality of selection target programs except for programs including the activation program; and a main memory construction unit configured to determine, in system shutdown processing, one or more selection target programs used on the system based on the use frequency of each of the plurality of selection target programs and load one of a selection target program necessary for the main memory apparatus and a part of the selection target program from the nonvolatile storage apparatus such that the determined one or more selection target programs and the activation program are stored in the main memory apparatus immediately after the system activation.

As described above, according to the embodiments of the present disclosure, it is possible to obtain excellent responsiveness in response to a user's request under a condition of a severe restriction on the capacity of a main memory apparatus.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a hardware configuration of an information processing apparatus according to an embodiment of the present disclosure;

FIG. 2 is a diagram showing program groups stored in a nonvolatile storage of FIG. 1 and a relationship of calling therebetween;

FIG. 3 is a flowchart showing an operation from system activation processing to shutdown processing in the information processing apparatus of this embodiment; and

FIG. 4 is a diagram showing a state of a change in contents stored in a RAM (Random Access Memory) from the system activation processing to the shutdown processing.

### DETAILED DESCRIPTION OF EMBODIMENTS

Hereinafter, an embodiment of the present disclosure will be described with reference to the drawings.

This embodiment relates to an information processing apparatus in which an energized state of a RAM (Random Access Memory) used as a main memory apparatus even under suspension of a system whose power switch is turned off is secured and accordingly contents of a main memory at a time of system shutdown are taken over at the next system activation. The information processing apparatus of this embodiment manages, during system operation, use frequencies of a plurality of selection target programs excluding a part of programs including an activation program necessary to activate the system. In system shutdown processing, the information processing apparatus of this embodiment determines one or more selection target programs used on the system based on the use frequencies of the plurality of selection target programs and loads a program necessary for the RAM or a part thereof from a nonvolatile storage apparatus such that the determined one or more selection target programs and the activation program are stored in the RAM immediately after the system is activated. Accordingly, under a condition of a severe restriction on the capacity of the RAM, excellent responsiveness can be obtained in response to a user's request. Hereinafter, a more specific embodiment will be described.

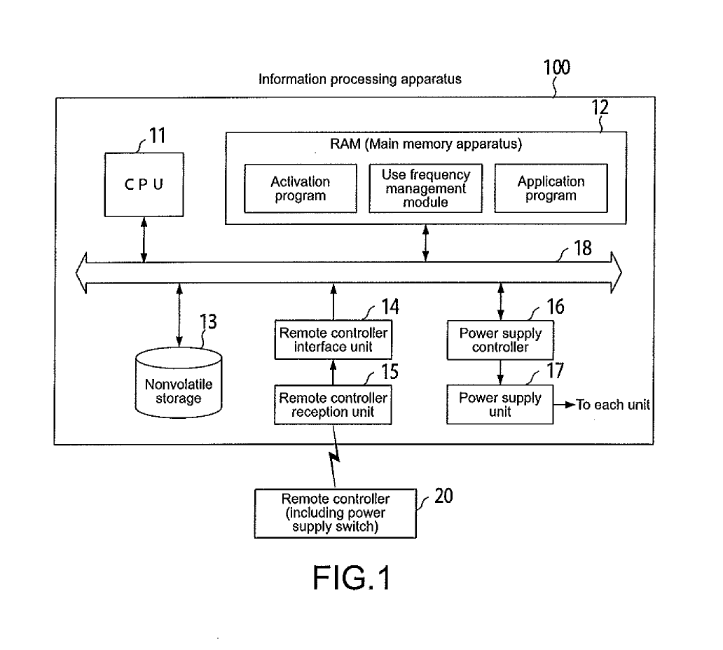

FIG. 1 is a diagram showing a hardware configuration of an information processing apparatus according to an embodiment of the present disclosure.

As shown in FIG. 1, the information processing apparatus 100 includes a CPU (Central Processing Unit) 11, a RAM (Random Access Memory) 12 as a main memory apparatus, a nonvolatile storage 13, a remote controller interface unit 14, a remote controller reception unit 15, a power supply controller 16, a power supply unit 17, a system bus 18, and the like.

The CPU 11 reads a program stored in the RAM 12 as a main memory apparatus and executes processing.

The RAM 12 as a main memory apparatus is a constantly-energized volatile storage apparatus in which a program to be read and processed by the CPU 11 is stored, an energized state is secured even under suspension of a system whose power switch is turned off, and accordingly contents of a main memory at a time of system shutdown are taken over at the next system activation. It should be noted that the contents stored in the RAM 12 shown in FIG. 1 are program groups at a time of system activation.

The nonvolatile storage 13 is specifically a nonvolatile storage apparatus having a relatively large capacity (at least having larger capacity than that of RAM 12), such as an HDD (Hard disk drive), an SDD (Solid State Drive), or a nonvolatile memory card. The nonvolatile storage 13 stores a plurality of programs to be loaded into the RAM 12 and processed by the CPU 11. The types of stored programs will be described later.

The remote controller reception unit 15 receives a remote operation signal that is transmitted from the remote controller 20 via carriers such as light or electromagnetic waves, and supplies the signal to the remote controller interface unit 14 as an electrical signal. The remote controller 20 receives instructions of various operations from a user to the information processing apparatus 100, and transmits remote operation signals corresponding to the instructions. The instructions that can be received by the remote controller 20 from the user include, for example, an instruction to switch on/off of a power supply of the information processing apparatus 100. It should be noted that the instruction to switch on/off of the power supply may be input with a main switch (not shown) or the like provided to a main body of the information processing apparatus 100.

The power supply unit 17 is, for example, a battery unit, a power supply circuit that generates rated electric power used in the information processing apparatus 100 from a commercially available power supply, or the like.

The power supply controller 16 controls the supply of electric power from the power supply unit 17 to each unit of the information processing apparatus 100. Specifically, upon reception of the instruction to switch the power supply on, the CPU 11 instructs the power supply controller 16 to start supply of the electric power to each unit of the information processing apparatus 100. Upon reception of the instruction to switch the power supply off, the CPU 11 instructs the power supply controller 16 to stop supply of the electric power to units excluding at least the RAM 12 or the like.

### Program Stored in Nonvolatile Storage 13]

Next, a program stored in the nonvolatile storage 13 will be described.

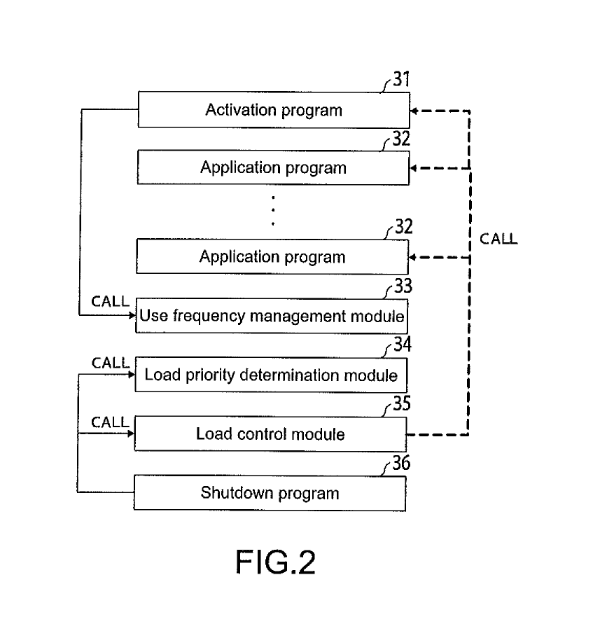

FIG. 2 is a diagram showing program groups stored in the nonvolatile storage 13 and a relationship of calling therebetween.

The nonvolatile storage 13 stores a plurality of programs as follows.

1. Activation program 31: The activation program 31 is a program necessary to activate a system. The information processing apparatus 100 executes various types of internal processing in order to activate a system. Although specific contents to be processed vary depending on apparatuses, the contents are, for example, processing of preparing an execution environment of programs other than the activation program 31, such as initialization of hardware (excluding RAM 12) or activation of a kernel. The activation program 31 also executes processing of calling a use frequency management module.

2. Application program 32: The application program is a program selectively designated by a user for use (corresponding to a selection target program). The nonvolatile storage 13 stores a plurality of application programs 32. When selected by the user, the application program 32 is read from the nonvolatile storage 13 and loaded into the RAM 12. The types of application programs 32 stored in the nonvolatile storage 13 vary depending on a product form or use application of the information processing apparatus 100. Further, the application program 32 is a program that can be newly introduced from the outside or deleted by the user.

3. Use frequency management module 33: The use frequency management module 33 is a program that is called by the activation program 31 and used for mainly managing the use frequency of the individual application programs 32 (corresponding to use frequency management unit). Here, the use frequency is, for example, the number of reads from the nonvolatile storage 13 and loads, or the like.

4. Load priority determination module 34: The load priority determination module 34 is a program that is called by a shutdown program and used for calculating a load priority for each application program 32 based on the use frequency of each application program 32 managed by the use frequency management module 33 (corresponding to main memory construction unit).

Methods of calculating the load priority based on the use frequency are as follows, for example:
A. Method of merely raising the priority as a value of the use frequency is larger; and
B. Method of setting the weight of the use frequency for each application program 32, and raising the priority as a value of the use frequency with the weight is larger.

According to the method B, for example, by setting the weight of a use frequency of an application program 32 having a relatively large size consumed in the RAM 12 to be lower and setting the weight of a use frequency of an application program 32 having a relatively smaller size consumed in the RAM 12 to be higher, it is possible to avoid a case where the capacity of the RAM 12 is consumed to a large extent by the application program 32 having a large size consumed in the RAM 12 and another application program 32 having a relatively high priority is not loaded. In other words, the improvement of a use efficiency of the RAM 12 can be expected.

5. Load control module 35: The load control module 35 is a program that is called by the shutdown program and used for loading the application programs 32 into the RAM 12 at a time of system activation, the application programs 32 being loaded in a descending order of load priority determined by the load priority determination module 34 (corresponding to main memory construction unit).

6. Shutdown program 36: The shutdown program 36 is a program necessary to shut down the system. The shutdown program 36 is a program for loading the load control module 35 into the RAM 12 at a time of system shutdown. Therefore, the load control module 35 can be handled as a program that is not managed by the use frequency management module 33, like the activation program 31 and the shutdown program 36.

### [System Activation Processing to Shutdown Processing]

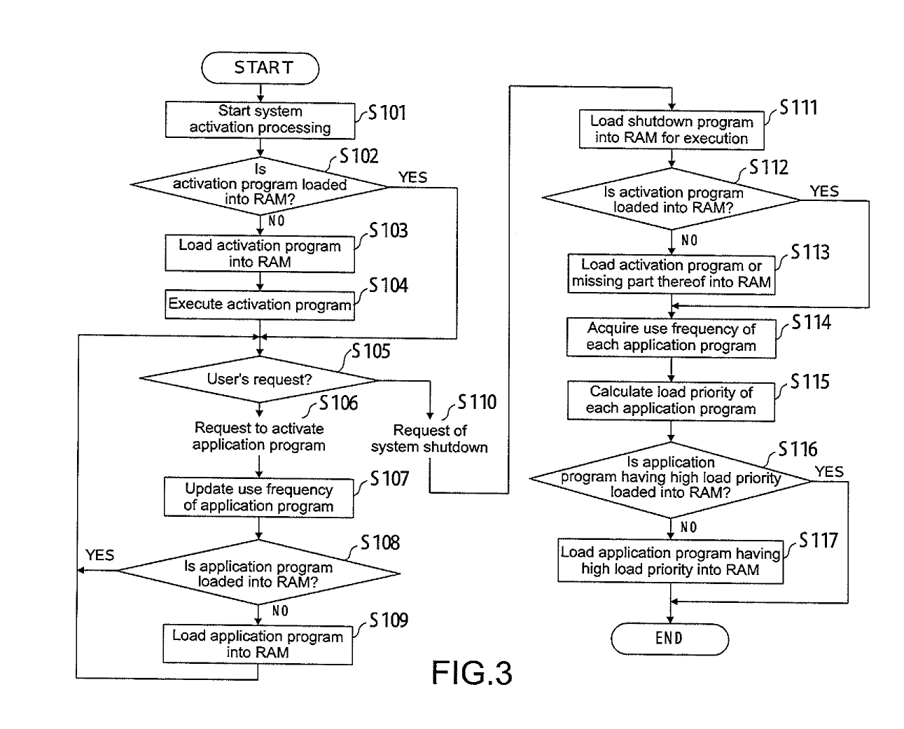

Next, an operation from system activation processing to shutdown processing in the information processing apparatus 100 of this embodiment will be described with reference to the flowchart of FIG. 3.

First, upon input of a request to activate the system from the user with use of the remote controller 20 or the main switch, a request to activate the system is input to the CPU 11. The CPU 11 starts system activation processing in accordance with the activation request (Step S101). In other words, the CPU 11 determines whether the activation program 31 is loaded into the RAM 12 in this activation processing (Step S102). In this embodiment, the activation program 31 is supposed to be stored in the RAM 12 in the last system shutdown processing (YES in Step S102), and therefore the activation program 31 is executed (Step S104). However, in the case where the load of the activation program 31 has failed in the last system shutdown processing and the activation program 31 is not stored in the RAM 12 (NO in Step S102), the CPU 11 loads the activation program 31 into the RAM 12 anew at a time of system activation (Step S103).

The CPU 11 executes internal processing necessary to activate the system based on the activation program 31 in Step S104. Further, the CPU 11 loads the use frequency management module 33 from the nonvolatile storage 13 into the RAM 12 based on the activation program 31. Accordingly, the use frequency management module 33 is activated.

After that, upon reception of a request from the user (Step S105), the CPU 11 recognizes the request from the user. Here, the request from the user includes an “activation request of application program”, a “system shutdown”, and the like. The case where an “activation request of application program” is generated will now be described.

Upon reception of the “activation request of application program” (Step S106), the CPU 11 updates the use frequency of a corresponding application program 32 based on the use frequency management module 33 (Step S107). After that, it is determined whether the application program 32 is loaded into the RAM 12 (Step S108). In the case where the application program 32 is not loaded, the application program 32 is loaded into the RAM 12 from the nonvolatile storage 13 (Step S109). Then, the CPU 11 returns to a state of waiting a request from the user. Here, in the case where the application program 32 in question has a high use frequency, the application program 32 is stored in the RAM 12 in the last system shutdown processing. Therefore, the load is not performed anew.

Next, the case where a request from the user is a “system shutdown” in Step S105 will now be described.

In Step S105, when determining that a request from the user is a “system shutdown” (Step S110), the CPU 11 reads the shutdown program 36 from the nonvolatile storage 13 and loads the shutdown program 36 into the RAM 12 for execution (Step S111).

The CPU 11 loads the load priority determination module 34 and the load control module 35 from the nonvolatile storage 13 into the RAM 12 according to the shutdown program 36. Then, according to the load priority determination module 34 and the load control module 35, the CPU 11 performs processing for constructing an optimum environment as the contents stored in the RAM 12 at a time of system activation from the viewpoint of responsiveness to the user's request, as follows.

The CPU 11 first determines whether all the activation programs 31 are loaded into the RAM 12 according to the load control module 35 (Step S112). Here, the activation programs 31 become unnecessary after the system is activated, and accordingly the importance thereof on the system is lowered than that of the application programs 32. When the user calls some application program 32, the activation programs 31 may be partially or completely deleted in some cases in order to compensate for a shortage of a free space of the RAM 12. In this way, in the case where all the activation programs 31 are not loaded or a part of activation programs 31 is not loaded into the RAM 12, the CPU 11 loads the activation programs 31 or a missing part thereof from the nonvolatile storage 13 into the RAM 12 (Step S113). In the case where all the activation programs 31 are loaded into the RAM 12, the load is not performed anew.

Next, according to the load priority determination module 34, the CPU 11 acquires a value of the use frequency of each application program 32 managed by the use frequency management module 33 (Step S114), and calculates a load priority of each application program 32 (Step S115).

Next, the CPU 11 determines whether an application program 32 in question is loaded into the RAM 12 in a descending order of load priority determined by the load priority determination module 34 (Step S116). In the case where the application program 32 is not loaded into the RAM 12 (NO in Step S116), the CPU 11 loads the application program 32 from the nonvolatile storage 13 according to the load control module 35 (Step S117). In the case where the application program 32 is loaded into the RAM 12 (YES in Step S116), the load is not performed anew.

It should be noted that the load of the activation program 31 and the application program 32 having a high load priority into the RAM 12 is performed in the allowable range of a free area of the RAM 12. In other words, the activation program 31 is loaded first into the RAM 12, and then one or more application programs 32 are loaded into the RAM 12 in a descending order of load priority. In the case where the activation program 31 and the application program 32 are difficult to be loaded due to the shortage of the free area of the RAM 12, the CPU 11 deletes the application programs 32 in an ascending order of load priority from the RAM 12 in order to secure the free area of the RAM 12 that is necessary to load the activation program 31 and the application program 32.

By the load control module 35 as described above, an optimum environment as the contents stored in the RAM 12 at a time of system activation is constructed from the viewpoint of responsiveness to the user's request. After that, the CPU 11 executes internal processing for eventually shutting down the system according to the shutdown program 36, thus shutting down the system.

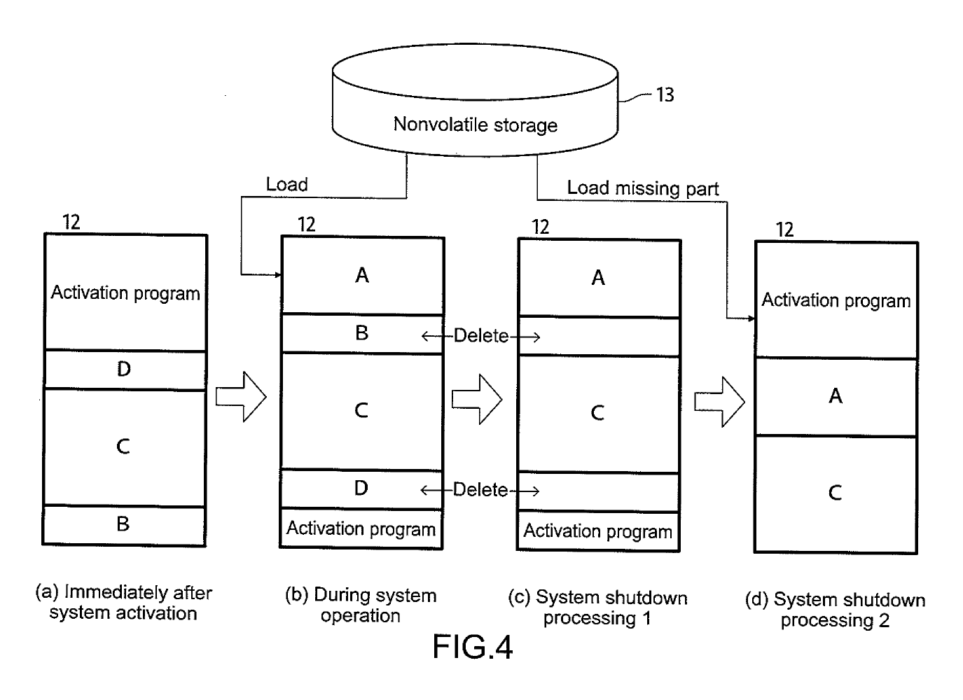

FIG. 4 is a diagram showing a state of a change in contents stored in the RAM 12 from the system activation processing to the shutdown processing descried above.

Part (a) of FIG. 4 shows the contents stored in the RAM 12 immediately after the system is activated, part (b) thereof shows the contents stored in the RAM 12, which are changed by an application program called by a user during the system operation, part (c) thereof shows Change 1 of the contents stored in the RAM 12 at a time of shutdown processing of the system, and part (d) thereof shows Change 2 of the contents stored in the RAM 12 at a time of shutdown processing of the system.

As shown in part (a) of FIG. 4, it is assumed that an activation program, an application program D, an application program C, and an application program B are stored in the RAM 12 immediately after the system is activated.

As shown in part (b) of FIG. 4, when the user calls an application program A during the system operation, the application program A is loaded into the RAM 12. However, since the RAM 12 has a shortage of a free space immediately before the application program A is loaded, a part of the activation program is deleted from the RAM 12 in order to compensate for the shortage.

As shown in part (c) of FIG. 4, it is assumed that in the system shutdown processing, a load priority based on a use frequency of each application program or the like is calculated and the application program A and the application program C are determined to each have a high load priority in the stated order. In this case, although the missing part of the activation program is loaded from the nonvolatile storage 13 into the RAM 12 in the highest priority, before that, the application program B and the application program D each having a lower load priority are deleted in the RAM 12 in order to secure a free space for storing the missing part of the activation program. Subsequently, since the application program A having the highest load priority and the application program C having the second highest load priority are loaded into the RAM 12, the application program A and the application program C remain (see part (d) of FIG. 4). In this way, the contents stored in the RAM 12 immediately before the system is restarted are constructed.

It should be noted that in part (c) of FIG. 4, the programs are continuously arranged in a memory space of the RAM 12, but processing of continuously arranging protocols in this way is not necessarily performed.

Through the processing described above, an environment in which the activation program 31 and one or more application programs 32 having a high load priority are stored in the RAM 12 is secured at a time of the next system activation, with the result that a time for loading the activation program 31 or a time for loading the application program 32 having a higher use frequency are totally shortened at a time of system activation. In other words, also under a condition of a severe restriction on the capacity of the RAM 12, a response time that elapses before a requested program is started to be processed in response to a user's request can be totally shortened.

It should be noted that the present disclosure is not limited to the embodiment described above, and can variously be modified within the technical idea of the present disclosure.

In the embodiment described above, the use frequency management unit is achieved by using the use frequency management module 33, and the main memory construction unit is achieved by using the load priority determination module 34 and the load control module 35, but the present disclosure is not limited to be achieved by software in this way. Each of the use frequency management unit and the main memory construction unit can also be achieved by using a dedicated logic circuit (hardware).

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a main memory apparatus configured to be capable of storing one or more programs read and processed by a central processing unit and holding stored contents by securing an energized state even under suspension of a system;
a nonvolatile storage apparatus configured to store in advance an activation program necessary to activate the system and a plurality of selection target programs available on the activated system;
a use frequency management unit configured to manage a use frequency of each of the plurality of selection target programs; and
a main memory construction unit configured to determine one or more selection target programs based on the use frequency of each of the plurality of selection target programs and load one of a program necessary for the main memory apparatus and a part of the program from the nonvolatile storage apparatus in system shutdown processing such that at least the determined one or more selection target programs and the activation program are stored in the main memory apparatus at a time of system activation.

2. The information processing apparatus according to claim 1, wherein
the main memory construction unit loads one of a missing selection target program and a part of the selection target program into the main memory apparatus from the nonvolatile storage apparatus such that the determined one or more selection target programs and the activation program are stored in the main memory apparatus immediately after the system activation.

3. The information processing apparatus according to claim 2, wherein
the main memory construction unit calculates a load priority for each of the plurality of selection target programs based on the use frequency of each of the plurality of selection target programs and a weight of the use frequency set in advance for each of the plurality of selection target programs, and determines one or more selection target programs used on the system based on the calculated load priority for each of the plurality of selection target programs.

4. The information processing apparatus according to claim 3, wherein
the main memory construction unit loads one of a selection target program necessary for the main memory apparatus and a part of the selection target program from the nonvolatile storage apparatus such that the determined one or more selection target programs and the activation program are stored in the main memory apparatus immediately after the system activation, and preferentially deletes, from the main memory apparatus, selection target programs in an ascending order of load priority out of the plurality of selection target programs stored in the main memory apparatus in a case where the main memory apparatus has a shortage of a free space.

5. An information processing method for an information processing apparatus including
a main memory apparatus configured to be capable of storing a program read and processed by a central processing unit and holding stored contents by securing an energized state even under suspension of a system, and
a nonvolatile storage apparatus configured to store in advance an activation program necessary to activate the system and a plurality of selection target programs available on the activated system, the information processing method comprising:
managing, by a use frequency management unit, a use frequency of each of the plurality of selection target programs except for programs including the activation program; and
determining, by a main memory construction unit, in system shutdown processing, one or more selection target programs used on the system based on the use frequency of each of the plurality of selection target programs and loading one of a selection target program necessary for the main memory apparatus and a part of the selection target program from the nonvolatile storage apparatus such that the determined one or more selection target programs and the activation program are stored in the main memory apparatus immediately after the system activation.

6. A program causing an information processing apparatus to operate, the information processing apparatus including
a main memory apparatus configured to be capable of storing a program read and processed by a central processing unit and holding stored contents by securing an energized state even under suspension of a system, and
a nonvolatile storage apparatus configured to store in advance an activation program necessary to activate the system and a plurality of selection target programs available on the activated system, the program causing the information processing apparatus to function as:
a use frequency management unit configured to manage a use frequency of each of the plurality of selection target programs except for programs including the activation program; and
a main memory construction unit configured to determine, in system shutdown processing, one or more selection target programs used on the system based on the use frequency of each of the plurality of selection target programs and load one of a selection target program necessary for the main memory apparatus and a part of the selection target program from the nonvolatile storage apparatus such that the determined one or more selection target programs and the activation program are stored in the main memory apparatus immediately after the system activation.
